(19) United States
(12) Patent Application Publication
(10) Pub. No.: US 2010/0089510 A1
(43) Pub. Date: Apr. 15, 2010

(54) Barrel formed bolt for repairing flat tire

(76) Inventor: Kun Yuan Tong, Suwanee, GA (US)

Correspondence Address: Kun Yuan Tong, 2842 Lowe Court, Suwanee, GA, 30024, US

(21) Appl. No.: 12/287,752

(22) Filed: Oct. 14, 2008

(51) Int. Cl. B29C 73/08

(52) U.S. Cl. 152/370

(57) ABSTRACT

The flat tire repair kit at present on the market contains band rubbers, a tube of super glue and a needle. It is very troublesome to repair a flat tire because the flat tire has to be removed from wheel before it can be repaired by the repair kit on market. Besides it is very hard to insert the band rubbers into nail hole with needle. The present invented barrel formed screw or barrel formed nail can repair flat tire while it is still on wheel. After applying super glue to the present invented barrel formed screw or barrel formed nail user can screw or hammer it into nail hole on flat tire while it is still on wheel. The form of barrel formed screw or barrel formed nail prevents it from coming loose. The submitted picture demonstrates only one of the possible drive design, which is a cross-shape. Barrel formed screw or barrel formed nail can be used temporarily to repair a flat tire before the nail hole can be repaired by a machinist at auto body shop. The barrel shaped screw or barrel shaped nail can stay permanently on tire if air leakage of tire does not reoccur. The present invented barrel formed screw or barrel formed nail comes in a kit which contains a barrel formed screw or a barrel formed nail, a tube of super glue and a screw driver.

### THE BACKGROUND OF THE INVENTION

It is troublesome to repair a flat tire especially in highway where no auto-body shop near. The flat tire repair kit at present on the market which contains an inserter, band rubber and super glue is not easy to use because the tire has to be removed from wheel. It is very hard to insert band rubber into nail hole on flat tire. The present invented barrel formed bolt, such as barrel-formed screw or barrel formed nail can be easily screwed or hammered into nail hole of a flat tire on wheel.

### THE BRIEF SUMMARY OF THE INVENTION

Barrel formed bolt, such as barrel formed screw or barrel formed nail, can be easily screwed or hammered into a nail hole of a flat tire to stop air leakage. User must apply super glue to lubricate the barrel-formed screw or nail to facilitate the insertion and to create an airtight seal. There is no chance for barrel formed screw or nail to get loose because of the form of barrel formed screw or nail and adhesion of super glue. Barrel formed screw, barrel formed nail, super glue and screw driver come in a kit.

### THE DETAILED DESCRIPTION OF THE DRAWING

FIG. 1 is a perspective view of a barrel formed screw.

FIG. 2 is a perspective view of a barrel formed nail.

### THE DETAILED DESCRIPTION OF THE INVENTION

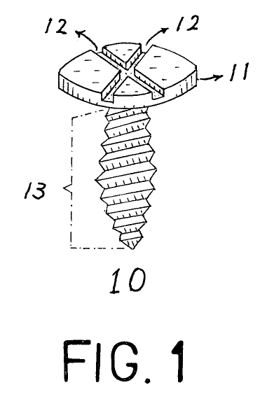

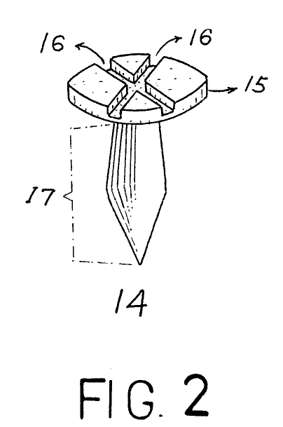

Referring now in detail to the drawings, numeral 10 of FIG. 1 is barrel-form screw Numeral 11 of FIG. 1 is cap of barrel formed screw 10. Numeral 12 of FIG. 1 is cross-shaped groove on the top of cap 11. Numeral 13 of FIG. 1 is barrel formed screw body of barrel formed screw 10. Numeral 14 of FIG. 2 is barrel formed nail. Numeral 15 of FIG. 2 is nail cap of-barrel formed nail 14. Numeral 16 of FIG. 2 is cross-shaped groove on the top of nail cap 15. Numeral 17 of FIG. 2 is barrel formed nail body of barrel formed nail 14. Before the insertion of barrel formed screw 10 or barrel formed nail 14 into nail hole of flat tire user has to apply super glue to barrel formed screw 10 or barrel formed nail 14 for lubrication to facilitate the insertion and to create an airtight sealing. Because of the form of barrel of barrel formed screw 10 or barrel formed nail 14 and the adhesion of super glue it is very hard for barrel formed screw 10 or barrel formed nail 14 to come loose. By driving car forward or backward slowly inch by inch one can turn nail hole on flat tire to face the back of car. Once turning nail hole on a flat tire to face the back of car user lubricates the barrel formed screw 10 or barrel formed nail 14 with super glue and inserts or hammers it into nail hole of flat tire while it is on wheel After the insertion of barrel formed screw 10 or barrel formed nail 14, user has to wait for a couple of minutes to let super glue set before he/she inflates the repaired flat tire. A flat tire repair kit contains a barrel formed screw, a barrel formed nail, a tube of super glue and a screw driver. Barrel formed bolt is of a variety of size.

1. Barrel formed bolt comprising a cap and a barrel formed body wherein diameter of middle of said body is wider than diameter of either end of said body.

2. Barrel formed bolt of claim 1 wherein said barrel formed body is a screw of the form of barrel.

3. Barrel formed bolt of claim 1 wherein said barrel formed body is a pin of the form of barrel.

4. Barrel formed bolt of claim 1 wherein said cap has a drive design across the middle of the top.

5. Barrel formed bolt of claim 4 wherein said drive design is cross-shaped groove on the top.

6. Barrel formed bolt of claim 4 wherein said drive design is I-shaped groove across the middle of the top.

7. Barrel formed bolt of claim wherein said cap has a flat top.

8. Barrel formed bolt of claim I wherein said pin of claim 3 is rubber coated pin of the form of barrel.

9. Barrel formed bolt of claim 1 wherein said pin of claim 3 is plain pin of the form of barrel.
